(19) United States
(12) Patent Application Publication
(10) Pub. No.: US 2018/0007070 A1
(43) Pub. Date: Jan. 4, 2018

(54) STRING SIMILARITY SCORE

(71) Applicant: McAfee, Inc., Santa Clara, CA (US)

(72) Inventors: Hrushikesh Narendra Kulkarni, Hillsboro, OR (US); Eric James Peterson, Parker, CO (US)

(73) Assignee: McAfee, Inc., Santa Clara, CA (US)

(21) Appl. No.: 15/201,077

(22) Filed: Jul. 1, 2016

(51) Int. Cl. H04L 29/06

(52) U.S. Cl. CPC H04L 63/1416; H04L 63/1425

(57) ABSTRACT

Particular embodiments described herein provide for an electronic device that can be configured to acquire a string, convert the string to an image, compare the image of the string to an image of a test string, and determine a similarity score. The similarity score provides an indication as to how visually similar the string is to the test string. In an example, the string is part of an attempt to spoof the test string.

### TECHNICAL FIELD

This disclosure relates in general to the field of information security, and more particularly, to a string similarity score.

### BACKGROUND

The field of network security has become increasingly important in today's society. The Internet has enabled interconnection of different computer networks all over the world. In particular, the Internet provides a medium for exchanging data between different users connected to different computer networks via various types of client devices. While the use of the Internet has transformed business and personal communications, it has also been used as a vehicle for malicious operators to gain unauthorized access to computers and computer networks and for intentional or inadvertent disclosure of sensitive information.

Malicious software (“malware”) that infects a host computer may be able to perform any number of malicious actions, such as stealing sensitive information from a business or individual associated with the host computer, propagating to other host computers, assisting with distributed denial of service attacks, sending out spam or malicious emails from the host computer, etc. Hence, significant administrative challenges remain for protecting computers and computer networks from malicious and inadvertent exploitation by malicious software.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for a string similarity score in accordance with an embodiment of the present disclosure;

FIG. 2 is a simplified block diagram illustrating example details of a portion of a communication system for a string similarity score, in accordance with an embodiment of the present disclosure;

FIG. 3 is a simplified block diagram illustrating example details of a portion of a communication system for a string similarity score, in accordance with an embodiment of the present disclosure;

FIG. 4 is a simplified flowchart illustrating potential operations that may be associated with the communication system in accordance with an embodiment;

FIG. 5 is a block diagram illustrating an example computing system that is arranged in a point-to-point configuration in accordance with an embodiment;

FIG. 6 is a simplified block diagram associated with an example system on chip (SOC) of the present disclosure; and

FIG. 7 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

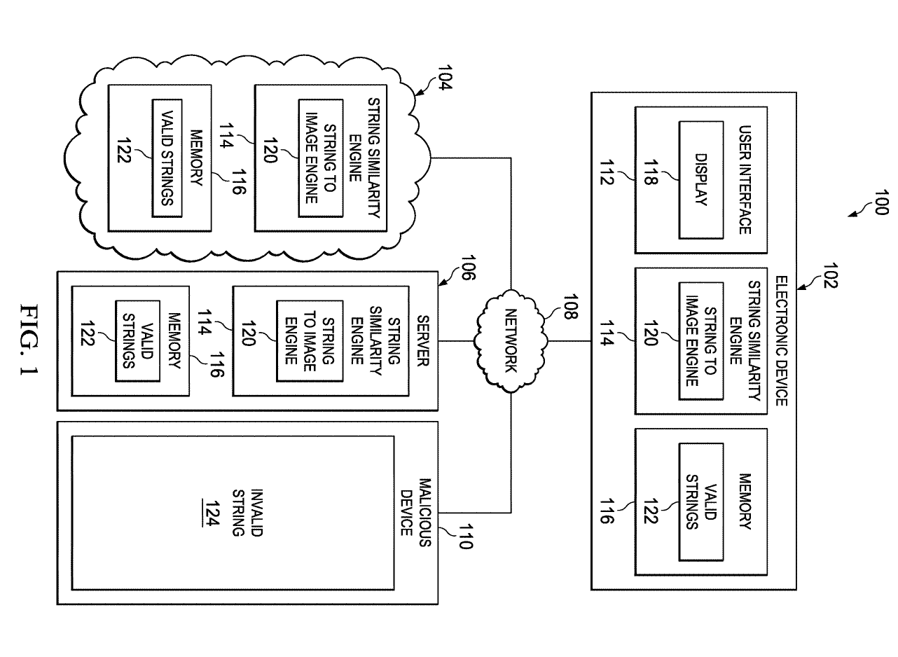

FIG. 1 is a simplified block diagram of a communication system 100 illustrating example details of a portion of a communication system for a string similarity score, in accordance with an embodiment of the present disclosure. As illustrated in FIG. 1, an embodiment of communication system 100 can include an electronic device 102, a cloud 104, and a server 106. Electronic device 102 can include a user interface 112, a string similarity engine 114, and memory 116. User interface can include display 118. String similarity engine 114 can include string to image engine 120. Memory 116 can include valid strings 122. Cloud 104 and server 106 can each include string similarity engine 114, which includes string to image engine 120 and memory 116, which includes valid strings 122. Electronic device 102, cloud 104, and server 106 may be in communication using network 108. In an example, malicious device 110 can attempt to infect electronic device 102 using an invalid string 124.

In an example, communication system 100 can be configured to convert invalid string 124 into an image. The image can be compared to one or more strings in valid strings 122 and a similarity score can be determined. If the similarity score is above a threshold score, or some other predetermined condition, then invalid string 124 may be determined to be malicious. If invalid string 124 were to be displayed on display 118, a user may believe that invalid string 124 was a legitimate string and allow malicious device 110 or malware to infect electronic device 102.

Elements of FIG. 1 may be coupled to one another through one or more interfaces employing any suitable connections (wired or wireless), which provide viable pathways for network (e.g., network 108) communications. Additionally, any one or more of these elements of FIG. 1 may be combined or removed from the architecture based on particular configuration needs. Communication system 100 may include a configuration capable of transmission control protocol/Internet protocol (TCP/IP) communications for the transmission or reception of packets in a network. Communication system 100 may also operate in conjunction with a user datagram protocol/IP (UDP/IP) or any other suitable protocol where appropriate and based on particular needs.

For purposes of illustrating certain example techniques of communication system 100, it is important to understand the communications that may be traversing the network environment. The following foundational information may be viewed as a basis from which the present disclosure may be properly explained.

Malicious software (“malware”) that infects a host computer may be able to perform any number of malicious actions, such as stealing sensitive information from a business or individual associated with the host computer, propagating to other host computers, assisting with distributed denial of service attacks, sending out spam or malicious emails from the host computer, etc. Hence, significant administrative challenges remain for protecting computers and computer networks from malicious and inadvertent exploitation by malicious software and devices. One way malicious operators can infect a host computer is to use spoofing.

Generally, spoofing is where a malicious operator or application masquerades as another legitimate operator or application by falsifying data. During a spoofing attack, the malicious operator or application takes advantage of the fact that many users overlook subtle changes in text such as email address or domain names and trick the user into clicking a malicious link or engaging in communications with a malicious operator. For example, a spoofed uniform resource locator (URL) can appear as a legitimate website but actually is another malicious website. During such an attack, a computer user innocently visits a web site and sees a familiar URL in the address bar but in reality, the URL may be to an entirely different malicious location. In another example, a spoofed email address, chat request, etc. can appear as legitimate but is actually associated with a malicious operator. A user may believe they are communicating with a legitimate known person when in reality, they are communicating with a malicious operator or program. What is needed is a way to identify a spoofed string. One method currently used to try and identify one text from another text is a Levenshtein distance. The Levenshtein distance is a string metric for measuring the difference between two sequences. However, the Levenshtein distance does not provide a reliable distinction between visually similar domains. What is needed is a way to identify a spoofed string.

A communication system for a string similarity score, as outlined in FIG. 1 can resolve these issues (and others). Communication system 100 may be configured to convert a string, such as text string, into a visual representation of the string. The string can be compared to a known sample string to calculate a relative similarity score. The higher the score, the more similar the strings. In an example, the converted string can be compared to known sample strings using a cross correlation score. The cross correlation score can then be compared to a threshold score and if the cross correlation score is above the threshold score, (e.g., above about 90% similarity) then the string may be considered as a spoof of a known string. The string can include a string of characters, text, numbers, or symbols of any length or any other identifying string from any form of communication, fixed or dynamic, that can be converted into an image file. The characters or symbols can include graphical characters, special characters, scientific characters, punctuation, emoticons, icons, etc. The string length can include two, fifty, one hundred, a thousand, etc. characters, text, numbers, or symbols and is only limited by memory, processing, and/or design considerations of the system. In some examples, the string may be part of a language and include words, portions of a word, phrases, sentences, paragraphs, etc.

Turning to the infrastructure of FIG. 1, communication system 100 in accordance with an example embodiment is shown. Generally, communication system 100 can be implemented in any type or topology of networks. Network 108 represents a series of points or nodes of interconnected communication paths for receiving and transmitting packets of information that propagate through communication system 100. Network 108 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, electronic device 102, cloud 104, and server 106 are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 100, each of electronic device 102, cloud 104, and server 106 can include memory elements (e.g., memory 112) for storing information to be used in the operations outlined herein. Each of electronic device 102, cloud 104, and server 106 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 100, such as electronic device 102, cloud 104, and server 106 may include software modules (e.g., string similarity engine 114 and string to image engine 120) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of electronic device 102, cloud 104, and server 106 may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Electronic device 102 can be a network element and includes, for example, desktop computers, laptop computers, mobile devices, personal digital assistants, smartphones, tablets, or other similar devices. Cloud 104 can be configured to provide cloud services to electronic device 102. Cloud services may generally be defined as the use of computing resources that are delivered as a service over a network, such as the Internet. Typically, compute, storage, and network resources are offered in a cloud infrastructure, effectively shifting the workload from a local network to the cloud network. Server 106 can be a network element such as a server or virtual server and can be associated with clients, customers, endpoints, or end users wishing to initiate a communication in communication system 100 via some network (e.g., network 108). The term ‘server’ is inclusive of devices used to serve the requests of clients and/or perform some computational task on behalf of clients within communication system 100. Although string similarity engine 114 and string to image engine 120 are represented in FIG. 1 as being located in electronic device 102, cloud 104, and server 106 this is for illustrative purposes only. String similarity engine 114 and string to image engine 120 could be combined or separated in any suitable configuration. Furthermore, s string similarity engine 114 and string to image engine 120 could be integrated with or distributed in another network accessible by electronic device 102.

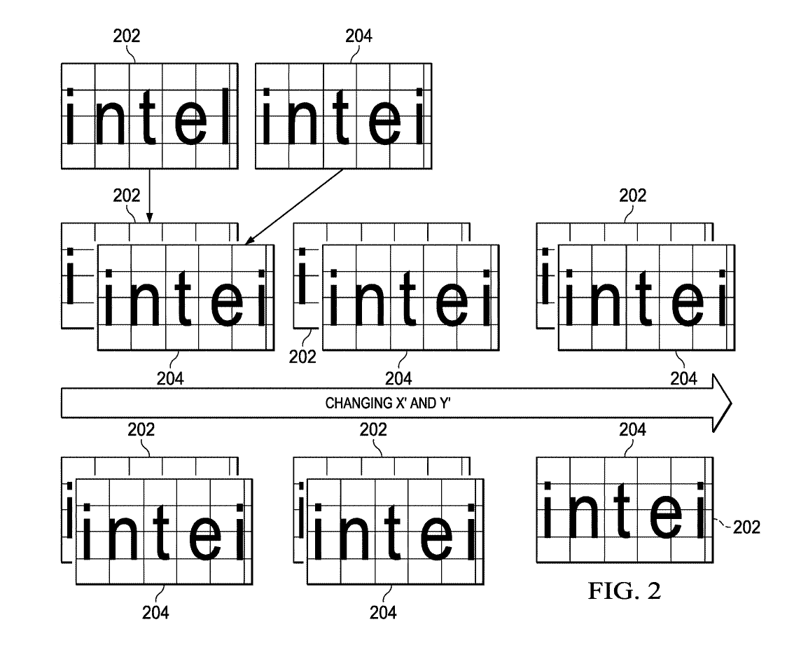

Turning to FIG. 2, FIG. 2 is a simplified block diagram illustrating example details of a portion of a communication system for a string similarity score, in accordance with an embodiment of the present disclosure. As illustrated in FIG. 2, a known string 202 can be compared to a spoof string 204. Spoof string 204 can be an invalid string (e.g., invalid string 124) or malicious string created by a malicious operator or malicious device (e.g., malicious device 110) to try and trick a user into believing spoof string 204 is known string 202. The text illustrated for known string 202 and spoof string 204 is for illustration purposes only. Known string 202 and spoof string 204 can each include a string of characters, numbers, or symbols of almost any length. In some examples, known string 202 and spoof string 204 may be part of a language and include words, portions of a word, phrases, sentences, paragraphs, etc.

Spoof string 204 may have been a string captured from an email address (e.g., reciepant@intei.com), from a URL (e.g., intei.com), or from some other data that a malicious operator or device may use to try and infect electronic device 102. Using string to image engine 120, the captured string can be converted to spoof string 204. During the comparison of known string 202 to spoof string 204, spoof string 204 can be rolled over (e.g., changing x′ and y′ with each iteration) known string 202, or vise-verse. As spoof string 204 is rolled over known string 202 a string similarity score can be calculated.

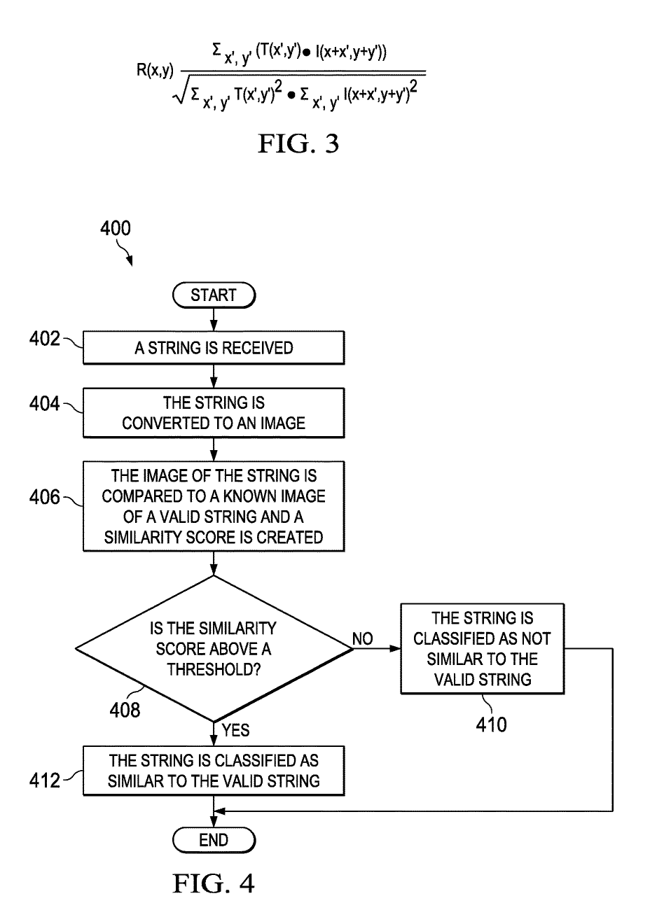

FIG. 3 is a simplified block diagram illustrating example details of a portion of a communication system for a string similarity score, in accordance with an embodiment of the present disclosure. In an example, to determine a string similarity score as spoof string 204 is rolled over known string 202 (as illustrated in FIG. 2), known string 202 and spoof string 204 can each be considered as including a group of numbers with known string 202 being represented by I(x,y) and spoof string being represented by T(x,y), where “x” and “y” are X and Y coordinates of a pixel in each image. In a specific example, 0 can be represented as black while 255 can be represented as white. To calculate a similarity score for known string 202 and spoof string 204, the formula illustrated in FIG. 3 may be used as spoof string 204 is rolled over known string 202.

Turning to FIG. 4, FIG. 4 is an example flowchart illustrating possible operations of a flow 400 that may be associated with a string similarity score, in accordance with an embodiment. In an embodiment, one or more operations of flow 300 may be performed by string similarity engine 114 and string to image engine 120. At 402, a string is received. The string may be from a suspicious email address, URL, or some other string that is displayed on display 118 or is communicated to a user through user interface 112 or is from a sample of string data on a system. In an example, the string is from previously received email or Web browser history files. At 404, the string is converted into an image. At 406, the image of the string is compared to a known image of a valid string and a similarity score is created. For example, the image of the string may be compared to images of valid strings 122 and the string can be compared to the known image of a valid string using the process described in FIGS. 2 and 3. At 408, the system determines if the similarity score is above a threshold value. If the similarity score is not above a threshold value, then the string is classified as not similar to the valid string, as in 410. If the similarity score is above a threshold value, then the string is classified as similar to the valid string, as in 412, and could indicate a spoofing attempt. The threshold value can be almost any value where the higher the threshold value, the more similar the strings need to be to satisfy the threshold value.

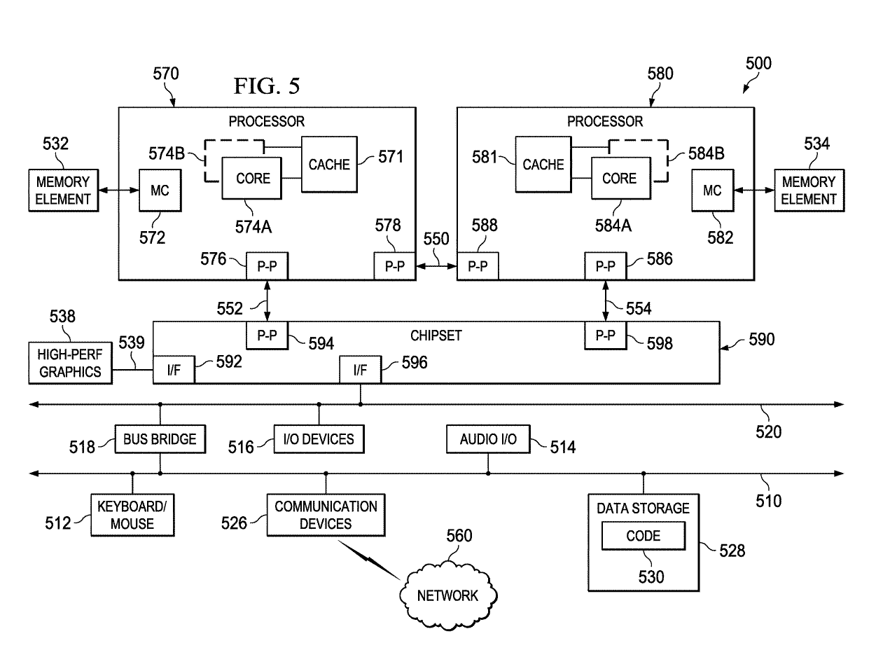

Turning to FIG. 5, FIG. 5 illustrates a computing system 500 that is arranged in a point-to-point (PtP) configuration according to an embodiment. In particular, FIG. 5 shows a system where processors, memory, and input/output devices are interconnected by a number of point-to-point interfaces. Generally, one or more of the network elements of communication system 100 may be configured in the same or similar manner as computing system 500. More specifically, string similarity engine 144 and string to image engine 120 can be configured in the same or similar manner as computing system 500.

As illustrated in FIG. 5, system 500 may include several processors, of which only two, processors 570 and 580, are shown for clarity. While two processors 570 and 580 are shown, it is to be understood that an embodiment of system 500 may also include only one such processor. Processors 570 and 580 may each include a set of cores (i.e., processor cores 574A and 574B and processor cores 584A and 584B) to execute multiple threads of a program. The cores may be configured to execute instruction code in a manner similar to that discussed above with reference to FIGS. 1-4. Each processor 570, 580 may include at least one shared cache 571, 581. Shared caches 571, 581 may store data (e.g., instructions) that are utilized by one or more components of processors 570, 580, such as processor cores 574 and 584.

Processors 570 and 580 may also each include integrated memory controller logic (MC) 572 and 582 to communicate with memory elements 532 and 534. Memory elements 532 and/or 534 may store various data used by processors 570 and 580. In alternative embodiments, memory controller logic 572 and 582 may be discreet logic separate from processors 570 and 580.

Processors 570 and 580 may be any type of processor and may exchange data via a point-to-point (PtP) interface 550 using point-to-point interface circuits 578 and 588, respectively. Processors 570 and 580 may each exchange data with a chipset 590 via individual point-to-point interfaces 552 and 554 using point-to-point interface circuits 576, 586, 594, and 598. Chipset 590 may also exchange data with a high-performance graphics circuit 538 via a high-performance graphics interface 539, using an interface circuit 592, which could be a PtP interface circuit. In alternative embodiments, any or all of the PtP links illustrated in FIG. 5 could be implemented as a multi-drop bus rather than a PtP link.

Chipset 590 may be in communication with a bus 520 via an interface circuit 596. Bus 520 may have one or more devices that communicate over it, such as a bus bridge 518 and I/O devices 516. Via a bus 510, bus bridge 518 may be in communication with other devices such as a keyboard/mouse 512 (or other input devices such as a touch screen, trackball, etc.), communication devices 526 (such as modems, network interface devices, or other types of communication devices that may communicate through a computer network 560), audio I/O devices 514, and/or a data storage device 528. Data storage device 528 may store code 530, which may be executed by processors 570 and/or 580. In alternative embodiments, any portions of the bus architectures could be implemented with one or more PtP links.

The computer system depicted in FIG. 5 is a schematic illustration of an embodiment of a computing system that may be utilized to implement various embodiments discussed herein. It will be appreciated that various components of the system depicted in FIG. 5 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

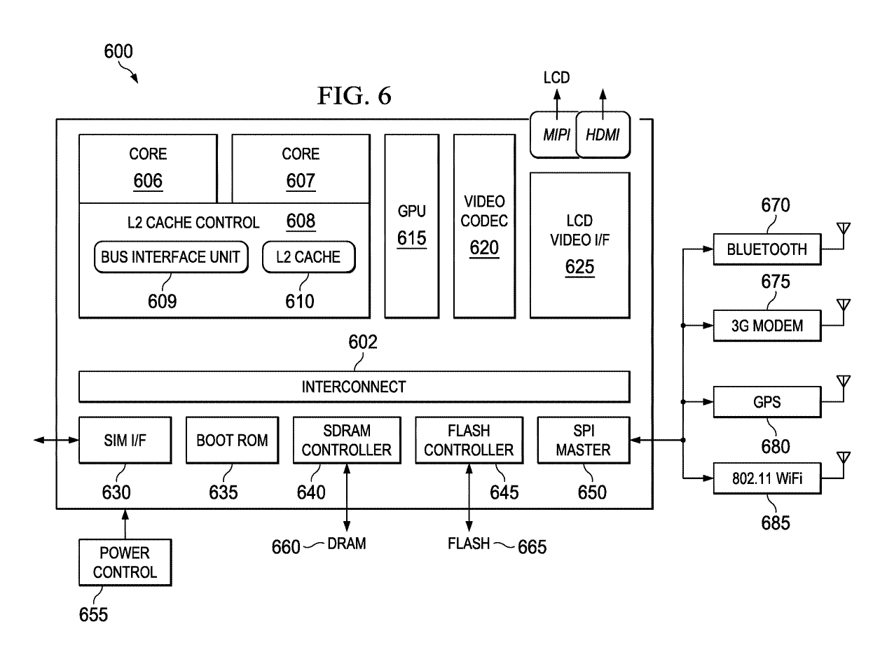

Turning to FIG. 6, FIG. 6 is a simplified block diagram associated with an example SOC 600 of the present disclosure. At least one example implementation of the present disclosure can include the detection of malicious strings features discussed herein. Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc. In an example, string similarity engine 144 and string to image engine 120 can be configured in the same or similar architecture as SOC 600.

In this example of FIG. 6, SOC 600 may include multiple cores 606-607, an L2 cache control 608, a bus interface unit 609, an L2 cache 610, a graphics processing unit (GPU) 615, an interconnect 602, a video codec 620, and a liquid crystal display (LCD) I/F 625, which may be associated with mobile industry processor interface (MIPI)/high-definition multimedia interface (HDMI) links that couple to an LCD.

SOC 600 may also include a subscriber identity module (SIM) I/F 630, a boot read-only memory (ROM) 635, a synchronous dynamic random access memory (SDRAM) controller 640, a flash controller 645, a serial peripheral interface (SPI) master 650, a suitable power control 655, a dynamic RAM (DRAM) 660, and flash 665. In addition, one or more example embodiments include one or more communication capabilities, interfaces, and features such as instances of Bluetooth™ 670, a 3G modem 675, a global positioning system (GPS) 680, and an 802.11 Wi-Fi 685.

In operation, the example of FIG. 6 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

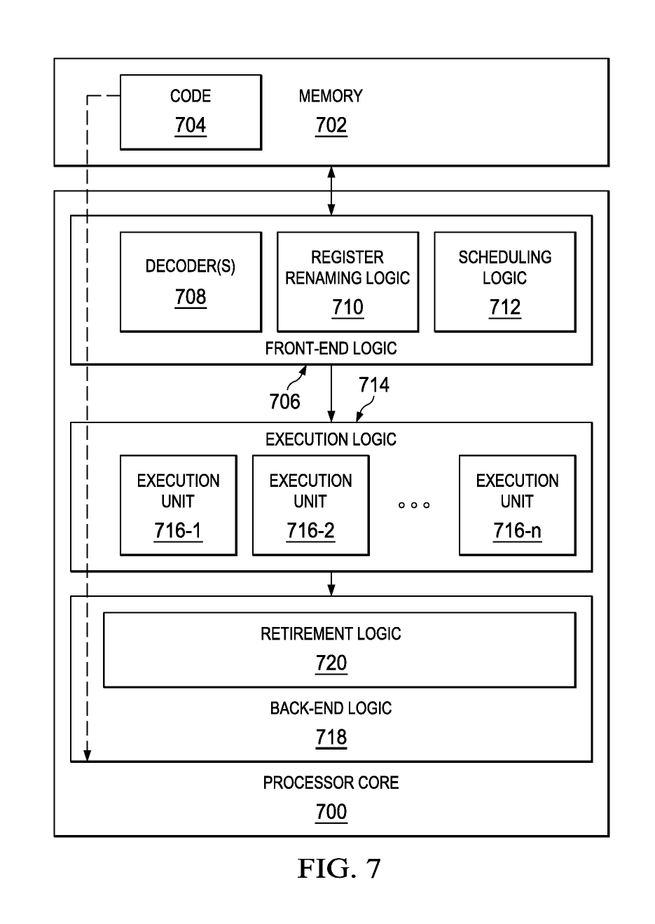

Turning to FIG. 7, FIG. 7 illustrates a processor core 700 according to an embodiment. Processor core 700 may be the core for any type of processor, such as a micro-processor, an embedded processor, a digital signal processor (DSP), a network processor, or other device to execute code. Although only one processor core 700 is illustrated in FIG. 7, a processor may alternatively include more than one of the processor core 700 illustrated in FIG. 7. For example, processor core 700 represents one example embodiment of processors cores 574a, 574b, 584a, and 584b shown and described with reference to processors 570 and 580 of FIG. 5. Processor core 700 may be a single-threaded core or, for at least one embodiment, processor core 700 may be multithreaded in that it may include more than one hardware thread context (or “logical processor”) per core.

FIG. 7 also illustrates a memory 702 coupled to processor core 700 in accordance with an embodiment. Memory 702 may be any of a wide variety of memories (including various layers of memory hierarchy) as are known or otherwise available to those of skill in the art. Memory 702 may include code 704, which may be one or more instructions, to be executed by processor core 700. Processor core 700 can follow a program sequence of instructions indicated by code 704. Each instruction enters a front-end logic 706 and is processed by one or more decoders 708. The decoder may generate, as its output, a micro operation such as a fixed width micro operation in a predefined format, or may generate other instructions, microinstructions, or control signals that reflect the original code instruction. Front-end logic 706 also includes register renaming logic 710 and scheduling logic 712, which generally allocate resources and queue the operation corresponding to the instruction for execution.

Processor core 700 can also include execution logic 714 having a set of execution units 716-1 through 716-N. Some embodiments may include a number of execution units dedicated to specific functions or sets of functions. Other embodiments may include only one execution unit or one execution unit that can perform a particular function. Execution logic 714 performs the operations specified by code instructions.

After completion of execution of the operations specified by the code instructions, back-end logic 718 can retire the instructions of code 704. In one embodiment, processor core 700 allows out of order execution but requires in order retirement of instructions. Retirement logic 720 may take a variety of known forms (e.g., re-order buffers or the like). In this manner, processor core 700 is transformed during execution of code 704, at least in terms of the output generated by the decoder, hardware registers and tables utilized by register renaming logic 710, and any registers (not shown) modified by execution logic 714.

Although not illustrated in FIG. 7, a processor may include other elements on a chip with processor core 700, at least some of which were shown and described herein with reference to FIG. 5. For example, as shown in FIG. 5, a processor may include memory control logic along with processor core 700. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and its teachings are readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures.

It is also important to note that the operations in the preceding flow diagram (i.e., FIG. 4) illustrate only some of the possible correlating scenarios and patterns that may be executed by, or within, communication system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 has been illustrated with reference to particular elements and operations that facilitate the communication process, these elements and operations may be replaced by any suitable architecture, protocols, and/or processes that achieve the intended functionality of communication system 100

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example C1 is at least one computer readable medium having one or more instructions that when executed by at least one processor cause the at least one processor to acquire a string, convert the string to an image, compare the image of the string to an image of a test string, and determine a similarity score, where the similarity score provides an indication as to how visually similar the string is to the test string.

In Example C2, the subject matter of Example C1 can optionally include where the similarity score is compared to a threshold value.

In Example C3, the subject matter of any one of Examples C1-C2 can optionally include where the string is part of an attempt to spoof the test string.

In Example C4, the subject matter of any one of Examples C1-C3 can optionally include where the string was included in an email address.

In Example C5, the subject matter of any one of Examples C1-C4 can optionally include where the string was included in a uniform resource locator.

In example C6, the subject matter of any one of Examples C1-05 can optionally include where the string includes one or more characters.

In Example A1, an apparatus can include a processor, memory, and a string similarity engine to acquire a string, convert the string to an image, compare the image of the string to an image of a test string, and determine a similarity score, where the similarity score provides an indication as to how visually similar the string is to the test string.

In Example, A2, the subject matter of Example A1 can optionally include where the similarity score is compared to a threshold value.

In Example A3, the subject matter of any one of Examples A1-A2 can optionally include where the string is part of an attempt to spoof the test string.

In Example A4, the subject matter of any one of Examples A1-A3 can optionally include where the string was included in an email address.

In Example A5, the subject matter of any one of Examples A1-A4 can optionally include where the string was included in a uniform resource locator.

In example A6, the subject matter of any one of Examples A1-A5 can optionally include where the string includes one or more characters.

Example M1 is a method including acquiring a string, converting the string to an image, comparing the image of the string to an image of a test string, and determining a similarity score, where the similarity score provides an indication as to how visually similar the string is to the test string.

In Example M2, the subject matter of Example M1 can optionally include where the similarity score is compared to a threshold value.

In Example M3, the subject matter of any one of the Examples M1-M2 can optionally include where the string is part of an attempt to spoof the test string.

In Example M4, the subject matter of any one of the Examples M1-M3 can optionally include where the string was included in an email address.

In Example M5, the subject matter of any of the Examples M1-M4 can optionally include where the string was included in a uniform resource locator.

In example M6, the subject matter of any one of Examples M1-M5 can optionally include where the string includes one or more characters.

Example S1 is a system for a string similarity score, the system including a string to image engine file type module configured to convert an acquired string into an image and a string similarity engine configured to compare the image of the string to an image of a test string and determine a similarity score, where the similarity score provides an indication as to how visually similar the string is to the test string.

In Example S2, the subject matter of Example S1 can optionally include where where the similarity score is compared to a threshold value.

In Example S3, the subject matter of any of the Examples S1-S2 can optionally include where the string is part of an attempt to spoof the test string.

In Example S4, the subject matter of any of the Examples S1-S2 can optionally include where the string was included in an email address.

In Example S5, the subject matter of any of the Examples S1-S2 can optionally include where the string was included in a uniform resource locator.

In example S6, the subject matter of any one of Examples S1-S5 can optionally include where the string includes one or more characters.

Example X1 is a machine-readable storage medium including machine-readable instructions to implement a method or realize an apparatus as in any one of the Examples A1-A6, or M1-M6. Example Y1 is an apparatus comprising means for performing of any of the Example methods M1-M6. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one computer-readable medium comprising one or more instructions that when executed by at least one processor, cause the at least one processor to:
acquire a string;
convert the string to an image;
compare the image of the string to an image of a test string; and
determine a similarity score, wherein the similarity score provides an indication as to how visually similar the string is to the test string.

2. The at least one computer-readable medium of claim 1, wherein the similarity score is compared to a threshold value.

3. The at least one computer-readable medium of claim 1, wherein the string is part of an attempt to spoof the test string.

4. The at least one computer-readable medium of claim 1, wherein the string was included in an email address or was included in a uniform resource locator.

5. The at least one computer-readable medium of claim 1, wherein the string includes one or more characters.

6. An apparatus comprising:
a processor;
memory; and
a string similarity engine to:
acquire a string;
convert the string to an image;
compare the image of the string to an image of a test string; and
determine a similarity score, wherein the similarity score provides an indication as to how visually similar the string is to the test string.

7. The apparatus of claim 6, wherein the similarity score is compared to a threshold value.

8. The apparatus of claim 6, wherein the string is part of an attempt to spoof the test string.

9. The apparatus of claim 6, wherein the string was included in an email address. or in a uniform resource locator

10. The apparatus of claim 6, wherein the string includes one or more characters.

11. A method comprising:
acquiring a string;
converting the string to an image;
comparing the image of the string to an image of a test string; and
determining a similarity score, wherein the similarity score provides an indication as to how visually similar the string is to the test string.

12. The method of claim 11, wherein the similarity score is compared to a threshold value.

13. The method of claim 11, wherein the string is part of an attempt to spoof the test string.

14. The method of claim 11, wherein the string was included in an email address or in a uniform resource locator.

15. The method of claim 11, wherein the string includes one or more characters.

16. A system for determining a string similarity score, the system comprising:
a processor;
memory;
a string to image engine to convert an acquired string into an image; and
a string similarity engine to:
compare the image of the string to an image of a test string; and
determine a similarity score, wherein the similarity score provides an indication as to how visually similar the string is to the test string.

17. The system of claim 16, wherein the similarity score is compared to a threshold value.

18. The system of claim 16, wherein the string is part of an attempt to spoof the test string.

19. The system of claim 16, wherein the string was included in an email address or in a uniform resource locator.

20. The system of claim 16, wherein the string includes one or more characters.
